(19) United States
(12) Patent Application Publication
(10) Pub. No.: US 2008/0197120 A1
(43) Pub. Date: Aug. 21, 2008

(54) Method For Producing a Hole and Associated Device

(75) Inventors: Thomas Beck, Panketal (DE); Silke Settegast, Berlin (DE); Lutz Wolkers, Berlin (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, MUENCHEN (DE)

(21) Appl. No.: 11/795,284

(22) PCT Filed: Dec. 21, 2005
(86) PCT No.: PCT/EP05/57030

§ 371 Date: Jul. 12, 2007

(30) Foreign Application Priority Data
Jan. 14, 2005 (EP) 05000729.3

(51) Int. Cl. B23K 26/38

(52) U.S. Cl. 219/121.71; 219/121.7

(57) ABSTRACT

Conventional methods for producing a hole in a component make use of special lasers with short laser pulse lengths. The aim of the invention is to reduce the time and money required for producing a hole. According to the inventive method, the laser pulse lengths are varied, short laser pulse lengths only being used in the area to be removed in which an influence on the throughflow or exhaust behavior is noticeable. This is, e.g., the inner surface of a diffuser of a hole that can be produced in a very precise manner using short laser pulse lengths.

### CROSS REFERENCE TO RELATED APPLICATIONS

This application is the US National Stage of International Application No. PCT/EP2005/057030, filed Dec. 21, 2005 and claims the benefit thereof. The International Application claims the benefits of European application No. 05000729.3 filed Jan. 14, 2005, both of the applications are incorporated by reference herein in their entirety.

### FIELD OF INVENTION

The invention relates to a method for producing a hole by means of pulsed energy beams in a component, and to a device with lasers.

### BACKGROUND OF THE INVENTION

With many components, especially with cast parts, cut-outs, like recesses or through-holes, have to be subsequently produced. Especially with turbine components, which have film cooling holes for cooling, holes are subsequently added after producing the component.

Such turbine components often also have coatings, like, for example, a metallic coating or intermediate coating and/or a ceramic outer coating. The film cooling holes then have to be produced through the coatings and the substrate (cast part).

U.S. Pat. No. 6,172,331 and also U.S. Pat. No. 6,054,673 disclose a laser boring method in order to add holes in coating systems, wherein ultrashort laser pulse lengths are used. A laser pulse length is selected from a defined laser pulse length range, and the hole is produced by it.

DE 100 63 309 A1 discloses a method for producing a cooling air opening by means of a laser, in which the laser parameters are adjusted so that material is removed by sublimating.

U.S. Pat. No. 5,939,010 discloses two alternative methods for producing a plurality of holes. In the one method (FIG. 1, 2 of the US-PS), one hole is first completely produced before the next hole is produced. In the second method, the holes are produced in steps, by a first section of a first hole first being produced, then a first section of a second hole being produced, and so on (FIG. 10 of the US-PS). In this case, different pulse lengths can be used in the two methods, but the same pulse lengths are always used within one method. The two methods cannot be linked together. The cross sectional area of the region from which material is to be removed always corresponds to the cross section of the hole which is to be produced.

U.S. Pat. No. 5,073,687 discloses the use of a laser for producing a hole in a component which is formed from a substrate with copper coating on both sides. In this case, a hole is first produced through a copper film by means of longer pulse durations, and then, by means of shorter pulses, a hole is produced in the substrate, which comprises a resin, wherein a hole is then produced through a copper coating on the rear side with higher power output of the laser. The cross sectional area of the region which has material removed corresponds to the cross section of the hole which is to be produced.

U.S. Pat. No. 6,479,788 B1 discloses a method for producing a hole, in which in a first step longer pulse lengths are used than in a further step. The pulse duration is varied in this case, in order to produce as good as possible a rectangular shape in the hole. In this case, the cross sectional area of the beam is also increased with decreasing pulse length.

The use of such ultrashort laser pulses is expensive and very time intensive on account of their low average power outputs.

### SUMMARY OF INVENTION

It is the object of the invention, therefore, to overcome this problem.

The object is achieved by a method in which different pulse lengths are used, wherein an energy beam is moved in the case of the shorter pulse lengths.

It is especially advantageous if shorter pulses are used only in one of the first material removal steps in order to produce optimum characteristics in an outer upper region of the joint face, since these are crucial for the outflow behavior of a medium from the hole and also for the flow circulating behavior of a medium around this hole. Inside the hole, the characteristics of the joint face are rather non-critical, so that longer pulses, which can create inhomogeneous joint faces, can be used there.

It is a further object to set forth a device by which the method can be simply and quickly implemented.

This object is achieved by a device according to the claims.

Further advantageous measures of the method or of the device are listed in the dependent claims of the method or of the device, as the case may be.

The measures which are listed in the dependent claims can be combined with each other in an advantageous manner.

### BRIEF DESCRIPTION OF THE DRAWINGS

The invention is explained in more detail with reference to the figures.

In the drawing

FIG. 1 shows a hole in a substrate,

FIG. 2 shows a hole in a coating system,

FIG. 3 shows a plan view of a through-hole which is to be produced,

FIGS. 4 to 11 show material removal steps of the method according to the invention,

FIGS. 12-15 show pieces of equipment according to the invention in order to implement the method,

FIG. 16 shows a turbine blade,

FIG. 17 shows a gas turbine and

FIG. 18 shows a combustion chamber.

### DETAILED DESCRIPTION OF THE INVENTION

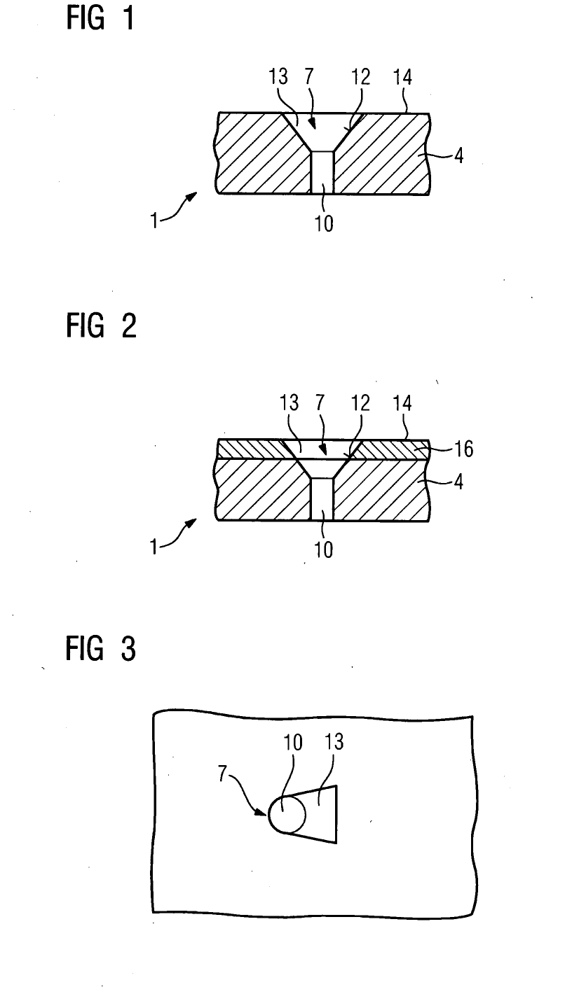

FIG. 1 shows a component 1 with a hole 7.

The component 1 comprises a substrate 4 (for example a cast part, or DS or SX component, as the case may be).

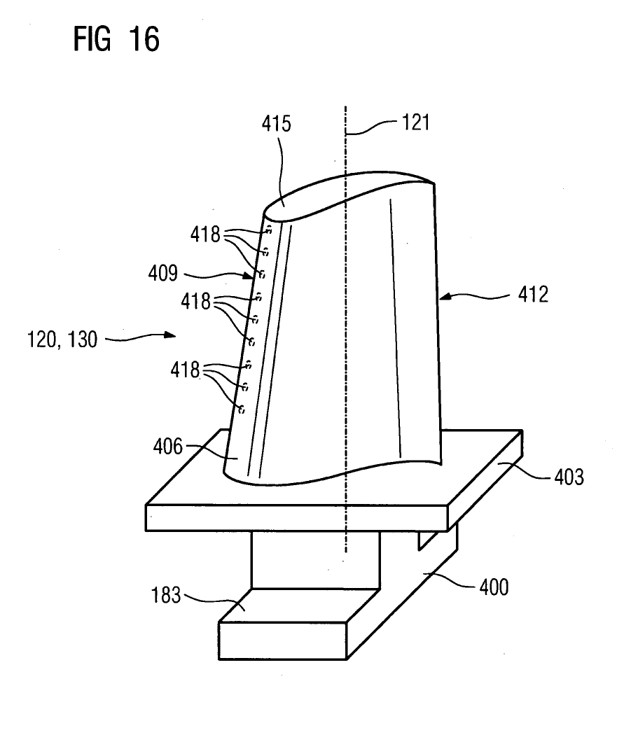

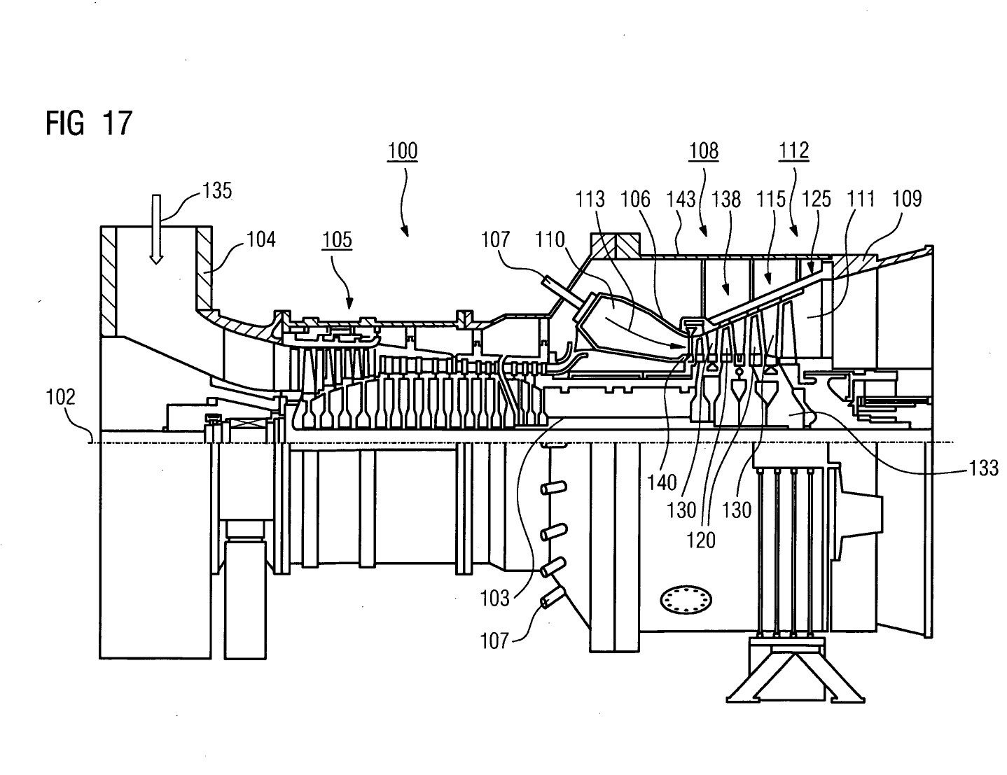

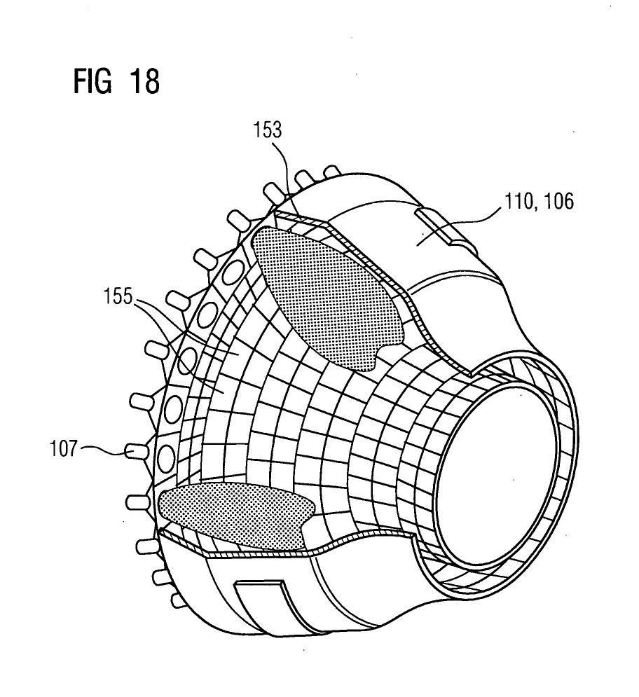

The substrate 4 can be metallic and/or ceramic. The substrate 4 consists of a nickel-based, cobalt-based or iron-based superalloy, especially in turbine components, like, for example, turbine rotor blades 120 or stator blades 130 (FIGS. 16, 17), heat shield elements 155 (FIG. 18), and also other casing components of a steam turbine or gas turbine 100 (FIG. 17), but also of an aircraft turbine. In the case of turbine blades for aircraft, the substrate 4 comprises, for example, titanium or a titanium-based alloy.

The substrate 4 has a hole 7, which for example is a through-hole. However, it can also be a blind hole. The hole 7 comprises a lower region 10 which originates from an inner side of the component 1 and which, for example, is formed symmetrically (for example circular, oval or rectangular-shaped), and an upper region 13 which is formed on an outer surface 14 of the substrate 4 as a diffuser 13, if applicable. The diffuser 13 represents a widening of the cross section in relation to the lower region 10 of the hole 7.

The hole 7, for example, is a film cooling hole. The inner surface 12 of the diffuser 13, that is in the upper region of the hole 7, should especially be smooth in order to enable an optimum outflow of a medium, especially an outflow of a cooling medium from the hole 7, because unevenesses create unwanted turbulences and deflections. Appreciably lower demands are made on the quality of the hole surface in the lower region 10 of the hole 7, since the flow behavior is only slightly influenced because of this.

FIG. 2 shows a component 1, which is constructed as a coating system.

There is at least one coating 16 on the substrate 4. This, for example, can be a metal alloy of the MCrAlX type, wherein M represents at least one element of the iron, cobalt or nickel group. X represents yttrium and/or at least one element of the rare earths.

The coating 16 can also be ceramic.

There can be yet another coating (not shown) on the MCrAlX coating, for example a ceramic coating, especially a thermal barrier coating (the MCrAlX coating is then an intermediate coating).

The thermal barrier coating, for example, is a completely stabilized or partially stabilized zirconium oxide coating, especially an EB-PVD coating or plasma-sprayed (APS, LPPS, VPS), HVOF or CGS (cold gas spraying) coating.

In this coating system 1, a hole 7 with the lower region 10 and the diffuser 13 is also introduced.

The aforesaid embodiments for producing the hole 7 apply to substrates 4 with and without a coating 16 or coatings 16.

FIG. 3 shows a plan view of a hole 7.

The lower region 10 could by produced by means of a cutting manufacturing method. However, in the case of the diffuser 13, this would not be possible, or only possible at very great expense.

The hole 7 can also extend at an acute angle to the surface 14 of the component 1.

Method

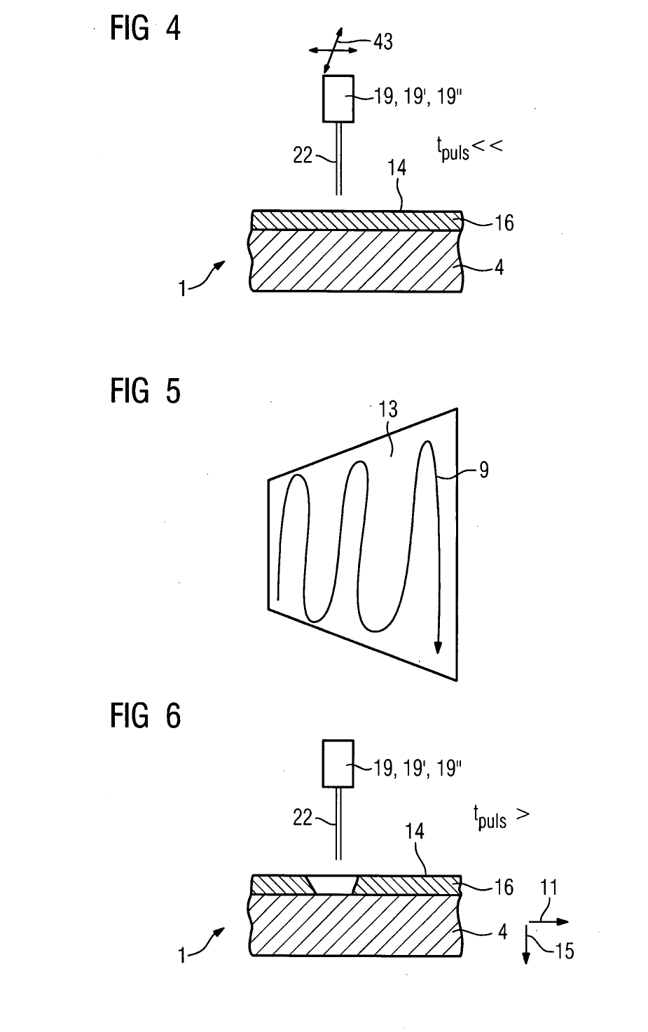

FIGS. 4, 5 and 6 show material removal steps of the method according to the invention.

According to the invention, energy beams 22 with different pulse lengths are used during the method.

The energy beam can be an electron beam, laser beam or high pressure water jet. In the following, the use of a laser is only exemplarily dealt with.

In one of the first material removal steps, shorter laser pulses (tpuls <<), which are less than or equal to 500 ns, especially less than or equal to 100 ns, are especially used. Laser pulse lengths in the region of picoseconds or femtoseconds can also be used.

When using shorter laser pulses which are less than or equal to 500 ns (nanoseconds), especially less than or equal to 100 ns, almost no melting takes place in the region of the joint face. Therefore, no cracks are formed on the inner surface 12 of the diffuser 13, and accurate, even geometries can be thus created.

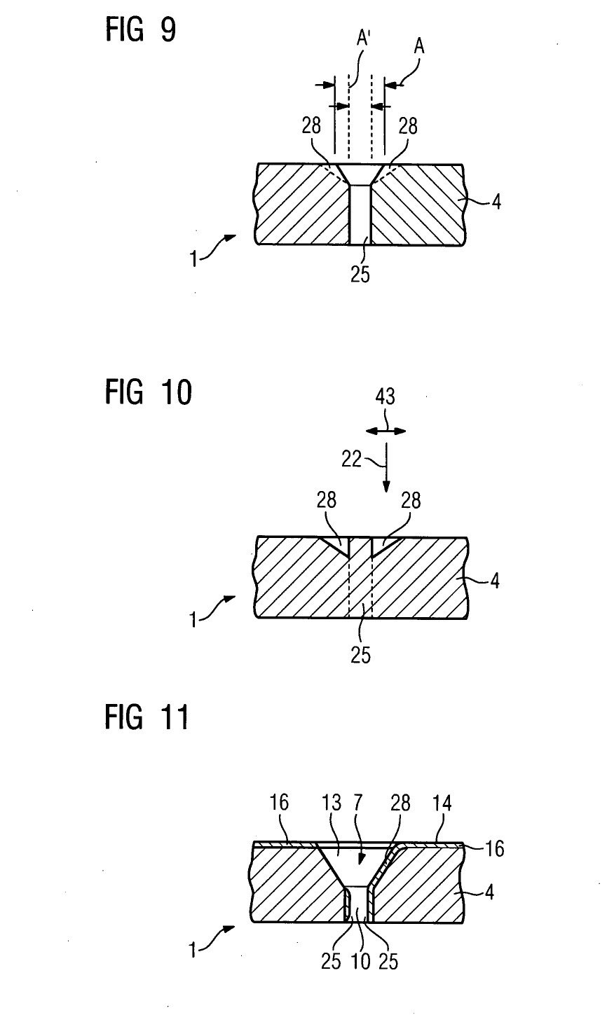

In one of the first material removal steps, a first section of the hole 7 is produced in the component 1. This, for example, can at least partially or completely correspond to the diffuser 13 (FIGS. 6, 9). The diffuser 13 for the most part is arranged in a ceramic coating. A shorter pulse length is especially used for producing the complete diffuser 13. A constant shorter pulse length is especially used for producing the diffuser 13. The time for producing the diffuser 13 in the method, for example, corresponds to the first material removal steps.

When producing the diffuser 13, a laser 19, 19′, 19″ with its laser beams 22, 22′, 22″ is moved back and forth in a lateral plane 43, as it is shown, for example, in FIG. 5. The diffuser 13 is moved along a line of travel 9, for example in meander-form, in order to remove material here in one plane (step FIG. 4, according to FIG. 6).

If a metallic intermediate coating or the substrate 4 is reached, longer laser pulse lengths (tpuls >) which are greater than 100 ns, especially greater than 500 ns and especially up to 10 ms, are preferably, but not necessarily, used in order to produce the remaining lower region 10 of the hole, as it is shown in FIG. 1 or 2.

The diffuser 13 is located at least for the most part in a ceramic coating, but it can also extend into a metallic intermediate coating 16 and/or into the metallic substrate 4, so that even metallic material can be removed as well, in part, with shorter pulse lengths. For producing the lower region 10 of the hole 7, mostly longer or completely longer, especially time-constant, laser pulses are especially used. The time for producing the lower region 10 corresponds to the last material removal steps in the method.

When using longer laser pulses, the at least one laser 19, 19′, 19″ with its laser beams 22, 22′, 22″, for example is not moved back and forth in the plane 43. Since the energy is distributed in the material of the coating 16 or of the substrate 4 on account of thermal conduction, and new energy is added by each laser pulse, material is extensively removed by material evaporation in a way that the surface in which the material is removed approximately corresponds to the cross sectional area A of the through-hole 7, 10 which is to be produced. This cross sectional area can be established by the energy power output and pulse duration, and also by the guiding of the laser beam.

The laser pulse lengths of a single laser 19, or a plurality of lasers 19′, 19″, for example can be continuously altered, for example from the beginning to the end of the method. The method begins with the removal of material on the outer surface 14, and ends when reaching the desired depth of the hole 7.

The material, for example, is progressively removed in layers in planes 11 (FIG. 6) and in an axial direction 15.

The pulse lengths can also be discontinuously altered. Two different pulse lengths are preferably used during the method. With the shorter pulse lengths (for example ≦500 ms), the at least one laser 19, 19′ is moved, and with the longer pulse lengths (for example 0.4 ms), for example it is not, because due to thermal conduction, the energy yield takes place anyway over a larger area than corresponding to the cross section of the laser beam.

During machining, the remaining part of the surface can be protected by a powder coating, especially by masking according to EP 1 510593 A1. The powder (BN, ZrO2) and the grain size distribution according to EP 1 510 593 A1 are part of this disclosure.

This is especially then sensible if a metallic substrate or a substrate with a metallic coating, yet which has no ceramic coating, is machined.

Laser Parameters

When using pulses with a defined pulse length, the power output of the laser 19, 19′, 19″, for example, is constant.

With the longer pulse lengths, a power output of the laser 19, 19′, 19″ of several 100 Watts, especially 500 Watts, is used.

With the shorter laser pulse lengths, a power output of the laser 19, 19′ of less than 300 Watts is used.

A laser 19, 19′ with a wavelength of 532 nm, for example, is used only for producing shorter laser pulses.

With the longer laser pulse lengths, a laser pulse duration of 0.4 ms and an energy (Joule) of the laser pulse of 6 J to 10 J, especially 8 J, are especially used, wherein a power output (Kilowatt) of 10 kW to 50 kW, especially 20 kW, is preferred.

The shorter laser pulses have an energy in the one-digit or two-digit Millijoule range (mJ), preferably in the one-digit Millijoule range, wherein the power output used for the most part especially lies in the one-digit Kilowatt range.

Number of Lasers

One laser 19, or two or more lasers 19′, 19″, as the case may be, can be used in the method, which are used simultaneously or consecutively. The similar or different lasers 19, 19′, 19″, for example, have different ranges with regard to their laser pulse lengths. In this way, for example a first laser 19′ can produce laser pulse lengths which are less than or equal to 500 ns, especially less than 100 ns, and a second laser 19″ can produce laser pulse lengths which are greater than 100 ns, especially greater than 500 ns.

For producing a hole 7, the first laser 19′ is used first. For further machining, the second laser 19″ is then used, or vice versa.

When producing the through-hole 7, even only one laser 19 can be used. A laser 19 is especially used which, for example, has a wavelength of 1064 nm and which can produce both the longer and the shorter laser pulses.

Sequence of the Hole Regions which are to be Produced

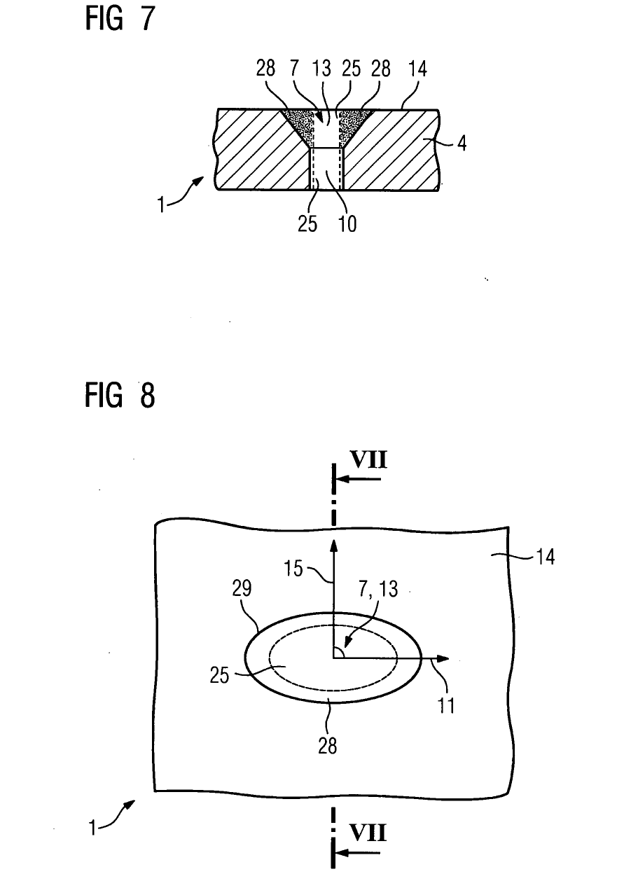

FIG. 7 shows a cross section through a hole 7.

In this case, a rough machining with laser pulse lengths which are greater than 100 ns, especially greater than 500 ns, is first carried out, and a fine machining with laser pulse lengths which are less than or equal to 500 ns, especially less than or equal to 100 ns, is carried out.

The lower region 10 of the hole 7 is completely machined, and only one region of the diffuser 13 is machined, for the most part with a laser 19 which has laser pulse lengths which are greater than 100 ns, especially greater than or equal to 500 ns (first material removal steps).

For completion of the hole 7 or of the diffuser 13, as the case may be, only a thinner, outer edge region 28 in the region of the diffuser 13 has to be machined by means of a laser 19, 19′, 19″ which can produce laser pulse lengths which are less than or equal to 500 ns, especially less than 100 ns (last material removal steps).

In this case, the laser beam is moved.

FIG. 8 shows a plan view of a hole 7 of the component 1. The different lasers 19, 19′, 19″ or the different laser pulse lengths of this laser 19, 19′, 19″, as the case may be, are used in different material removal steps.

For example, a rough machining with large laser pulse lengths (>100 ns, especially >500 ns) is first carried out. As a result, the largest part of the hole 7 is produced. This inner region is identified by the designation 25. Only an outer edge region 28 of the hole 7 or of the diffuser 13, as the case may be, has to be removed in order to achieve the final dimensions of the hole 7.

In this case, the laser beam 22, 22′ is moved in the plane of the surface 14.

Not until the outer edge region 28 has been machined by means of a laser 19, 19′ with shorter laser pulse lengths (<500 ns, especially <100 ns), is the hole 7 or the diffuser 13 finished.

The contour 29 of the diffuser 13 is consequently produced with shorter laser pulses, as a result of which the outer edge region 28 is removed in a finer and more accurate manner and so is free of cracks and fused areas.

The material, for example, is removed in one plane 11 (perpendicular to the axial direction 15).

With the longer pulse lengths, the cross section A of the region which is to be removed when producing the hole 7 can also be continuously reduced in the depth of the substrate 4 as far as A′, so that the outer edge region 28 in relation to FIG. 7 is reduced (FIG. 9). This is created by adjustments of energy and pulse duration.

An alternative when producing the hole 7 is to first produce the outer edge region 28 with shorter laser pulse lengths (≦500 ns) to a depth in the axial direction 15 which partially or wholly corresponds to an extent of the diffuser 13 of the hole 7 in this direction 15 (FIG. 10, the inner region 25 is indicated by broken lines).

In this case, the laser beam 22, 22′ in these first material removal steps is moved in the plane of the surface 14.

Therefore, almost no fused areas are produced in the region of the joint face of the diffuser 13 and no cracks are formed there, and accurate geometries can be produced in this way.

Only then is the inner region 25 removed (last material removal steps) with longer laser pulse lengths (>100 ns, especially >500 ns).

The method can be used with newly produced components 1, which were cast for the first time.

The method can also be used with components 1 which are to be refurbished.

Refurbishment means that components 1 which were in use, for example are separated from coatings and after repair, like, for example, filling of cracks and removal of oxidation and corrosion products, are newly coated again.

In this case, for example contaminants or coating material which was newly applied (FIG. 11) and got into the holes 7, are removed by a laser 19, 19′. Or special formings (diffusers) in the coating region are newly produced after recoating during the refurbishment.

Refurbishment

FIG. 11 shows the refurbishment of a hole 7, wherein during coating of the substrate 4 with the material of the coating 16, material is penetrated into the already existing hole 7.

For example, the deeper lying regions in the region 10 of the hole 7 can be machined with a laser which has laser pulse lengths which are greater than 100 ns, especially greater than 500 ns. These regions are identified by 25.

The more critical edge region 28, for example in the region of the diffuser 13, upon which there is contamination, is machined with a laser 19′ which has laser pulse lengths which are less than or equal to 500 ns, especially less than 100 ns.

Device

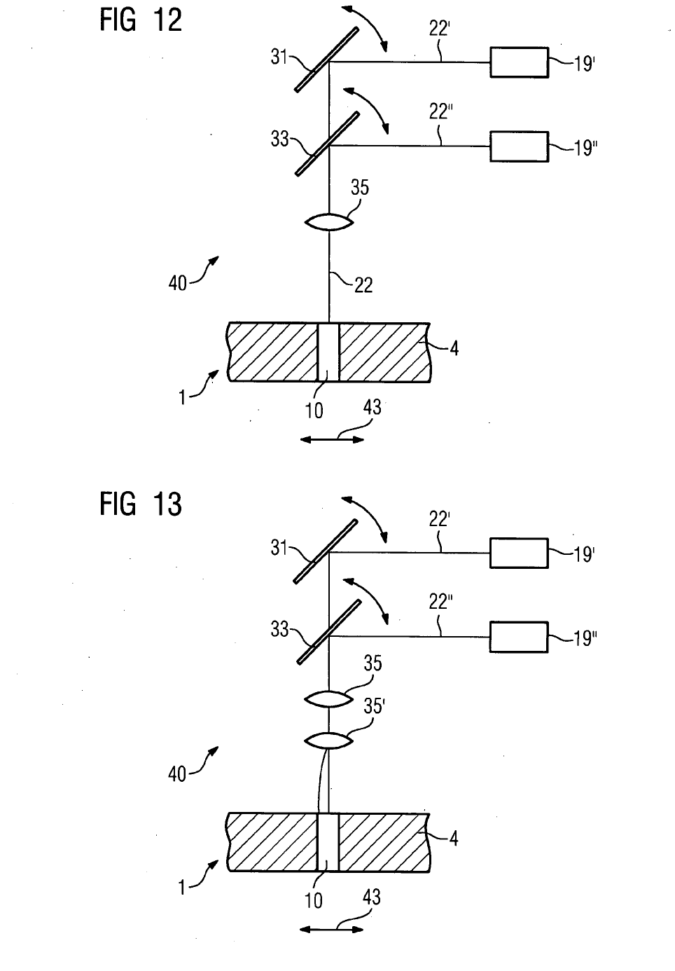

FIGS. 12 to 15 show exemplary devices 40 according to the invention in order to especially implement the method according to the invention.

The devices 40 comprise at least one optical device 35, 35′, especially at least one lens 35, 35′ which directs at least one laser beam 22, 22′, 22″ onto the substrate 4 in order to produce the hole 7.

There are one, two or more lasers 19, 19′, 19″.

The laser beams 22, 22′, 22″ can be guided towards the optical device 35, 35′ via mirrors 31, 33.

The mirrors 31, 33 are displaceable or rotatable, so that, for example, only one laser 19′, 19″ in each case can transmit its laser beams 22′ or 22″ onto the component 1 via the mirrors 31 or 33 and the lens 35.

The component 1, 120, 130, 155 or the optical device 35, 35′ or the mirrors 31, 33 are movable in one direction 43, so that the laser beam 22, 22′, for example according to FIG. 5, is moved over the component 1.

The lasers 19, 19′, 19″, for example, can have a wavelength of either 1064 nm or 532 nm. The lasers 19′, 19″ can have different wavelengths: 1064 nm and 532 nm. With regard to pulse length, for example the laser 19′ is adjustable to pulse lengths of 0.1-5 ms; whereas the laser 19′ is adjustable to pulse lengths of 50-500 ns.

By displacement of the mirrors 31, 33 (FIG. 12, 13, 14), the beam of the laser 19′, 19″ with such laser pulse lengths can be coupled in each case into the component 1 via the optical device 35, which are necessary, for example, in order to produce the outer edge region 28 or the inner region 25.

FIG. 12 shows two lasers 19′, 19″, two mirrors 31, 33 and an optical device in the form of a lens 35.

If, for example, the outer edge region 28 is first produced, according to FIG. 6, then the first laser 19′ with the shorter laser pulse lengths is coupled in.

If then the inner region 25 is produced, then by movement of the mirror 31, the first laser 19′ is decoupled, and by movement of the mirror 33, the second laser 19″ with its longer laser pulse lengths is coupled in.

FIG. 13 shows a similar device as in FIG. 12, however in this case there are two optical devices, in this case, for example, two lenses 35, 35′, which allow the laser beams 22′, 22″ of the lasers 19′, 19″ to be directed to different regions 15, 28 of the component 1, 120, 130, 155 simultaneously.

If, for example, an outer edge region 28 is produced, the laser beam 22′ can be directed onto a first point of this sheath-form region 28, and directed onto a second point which lies diametrically opposite the first point, so that the machining time is significantly shortened.

The optical device 35 can be used for the first laser beams 22′, and the second optical device 35′ can be used for the second laser beams 22″.

According to this device 40, the lasers 19′, 19″ could be used consecutively or simultaneously with the same or different laser pulse lengths.

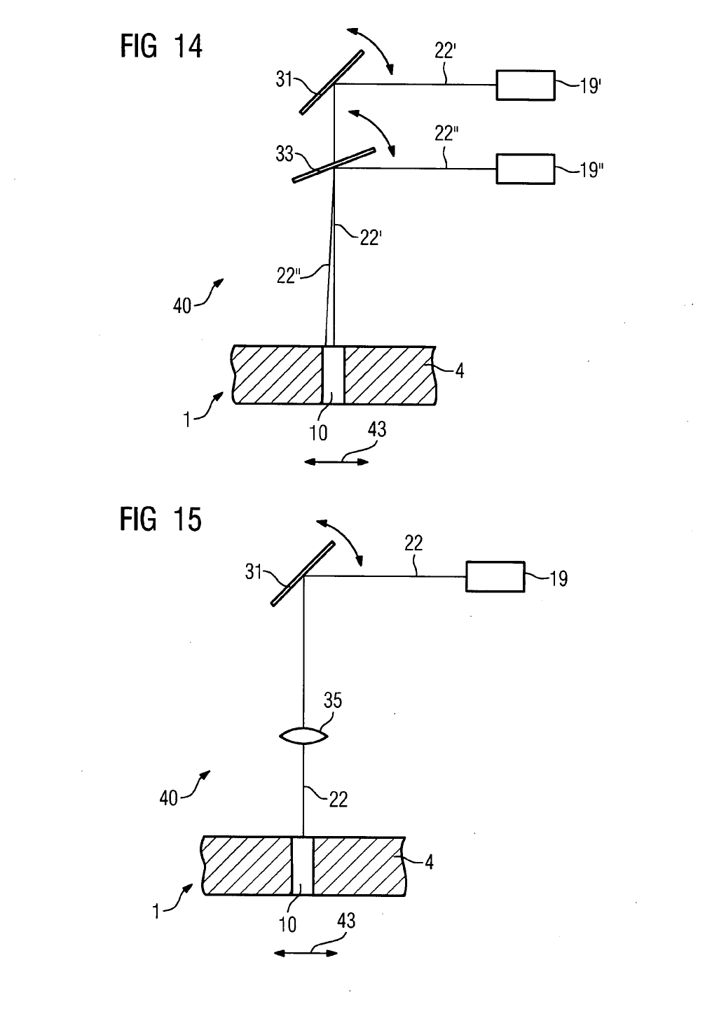

In FIG. 14, there are no optical devices in the form of lenses, but only mirrors 31, 33, which direct the laser beams 22′, 22″ onto the component 1 and by movement are used so that at least one laser beam 22′, 22″ is moved in one plane over the component.

The lasers 19′, 19″ in this case can also be used simultaneously.

According to this device 40, the lasers 19′, 19″ could be used consecutively or simultaneously, with the same or different laser pulse lengths.

FIG. 15 shows a device 40 with only one laser 19, with the laser beam 22, for example, being directed onto a component 1 via a mirror 31.

Also in this case, an optical device, for example in the form of a lens, is not necessary. The laser beam 22, for example, is moved over the surface of the component 1 by movement of the mirror 31. This is necessary when using shorter laser pulse lengths. With the longer laser pulse lengths, the laser beam 22 does not necessarily have to be moved, so that the mirror 31 is not moved like it is in the movement stage.

In the same way, however, one lens or two lenses 35, 35′ can also be used in the device according to FIG. 15 in order to direct the laser beam simultaneously onto different regions 25, 28 of the component 1, 120, 130, 155.

Components

FIG. 16 shows in perspective view a rotor blade 120 or stator blade 130 of a turbomachine, which blade extends along a longitudinal axis 121.

The turbomachine can be a gas turbine of an aircraft or of a power plant for generation of electricity, a steam turbine, or a compressor.

The blade 120, 130 has a fastening region 400, a blade platform 403 which adjoins it, and also a blade airfoil 406, which are arranged one after the other along the longitudinal axis 121.

As a stator blade 130, the blade 130 can have an additional platform (not shown) at its blade tip 415.

In the fastening region 400, a blade root 183 is formed, which serves for fastening of the rotor blades 120, 130 on a shaft or a disk (not shown).

The blade root 183, for example, is designed as an inverted T-root. Other developments as fir-tree roots or dovetail roots are possible.

The blade 120, 130 has a leading edge 409 and a trailing edge 412 for a medium which flows past the blade airfoil 406.

In conventional blades 120, 130, for example solid metal materials, especially superalloys, are used in all regions 400, 403, 406 of the blade 120, 130.

Such superalloys, for example, are known from EP 1 204 776 B1, EP 1 306 454, EP 1 319 729 A1, WO 99/67435 or WO 00/44949; these documents are part of the disclosure which refers to the chemical composition of the alloy.

The blade 120, 130 in this case can be manufactured by means of a casting process, also by means of directional solidification, by means of a forging process, by means of a milling process, or by a combination of these processes.

Workpieces with a single-crystal structure, or structures, are used as components for machines which, in operation, are exposed to high mechanical, thermal and/or chemical stresses. The manufacture of such single-crystal workpieces, for example, is carried out by directional solidification from the melt. This involves casting processes in which the liquid metallic alloy solidifies to form the single-crystal structure, i.e. the single-crystal workpiece, or solidifies directionally. In this case, dendritic crystals are oriented along the thermal flux and form either a stalk-like crystal grain structure (columnar, i.e. grains which extend over the whole length of the workpiece, and which here, in accordance with the language customarily used, are referred to as directionally solidified), or a single-crystal structure, i.e. the whole workpiece comprises a single crystal. In these processes, the transition to globulitic (polycrystalline) solidification needs to be avoided, since as a result of non-directional growth transverse and longitudinal grain boundaries are inevitably formed, which negate the favorable characteristics of the directionally solidified or single-crystal component.

If the text refers in general terms to directionally solidified microstructures, then this is to be understood as meaning both single crystals (5×), which have no grain boundaries or at most have small-angle grain boundaries, and also stalk-like crystal structures, which no doubt have grain boundaries which extend in the longitudinal direction but have no transverse grain boundaries. In these second-mentioned crystal structures, reference can also be made to directionally solidified microstructures (D9) (directionally solidified structures). Such processes are known from U.S. Pat. No. 6,024,792 and EP 0 892 090 A1; these documents are part of the disclosure.

Also, the blades 120, 130 can have coatings against corrosion or oxidation, for example (MCrAlX; M is at least one element of the iron (Fe), cobalt (Co), nickel (Ni) group, X is an active element and represents yttrium (Y) and/or silicon and/or at least one element of the rare earths, or hafnium (Hf), as the case may be). Such alloys are known from EP 0 486 489 B1, EP 0 786 017 B1, EP 0 412 397 B1, or EP 1 306 454 A1, which are to be part of this disclosure which refers to the chemical composition of the alloy.

There can still be a thermal barrier coating on the MCrAlX, and, for example, comprises ZrO₂, Y₂O₄—ZrO₂, i.e. it is not partially or completely stabilized by yttrium oxide and/or by calcium oxide and/or by magnesium oxide.

By suitable coating processes, like, for example, electron beam physical vapor deposition (EB-PVD), stalk-shaped grains are created in the thermal barrier coating.

Refurbishment means that components 120, 130, after their use, if necessary need to be freed of protective coatings (for example, by sand-blasting). After that, removal of the corrosion and/or oxidation coatings, or products, as the case may be, is carried out. If necessary, cracks in the component 120, 130 are repaired as well. Then, recoating of the component 120, 130 and refitting of the component 120, 130 is carried out.

The blade 120, 130 can be constructed hollow or solid. If the blade 120, 130 is to be cooled, it is hollow and, if necessary, still has film cooling holes 418 (shown by broken lines).

FIG. 17 exemplarily shows a gas turbine 100 in a longitudinal partial section.

Inside, the gas turbine 100 has a rotor 103, also described as a turbine rotor, which is rotatably mounted around a rotational axis 102.

An intake duct 104, a compressor 105, a combustion chamber 110, for example a toroidal combustion chamber, especially an annular combustion chamber 106, with a plurality of coaxially arranged burners 107, a turbine 108 and the exhaust duct 109, are arranged in series along the rotor 103.

The annular combustion chamber 106 communicates with a hot gas passage 111, for example an annular hot gas passage. There, turbine stages 112, for example four turbine stages, which are connected one behind the other, form the turbine 108.

Each turbine stage 112 is formed from two blade rings. Viewed in the flow direction of a working medium 113, a row 125 which is formed from rotor blades 120 follows a stator blade row 115 in the hot gas passage 111.

The stator blades 130 in this case are fastened on an inner casing 138 of a stator 143, whereas the rotor blades 120 of a row 125 are attached on the rotor 103, for example by means of a turbine disk 133. A generator or a driven machine (not shown) is coupled to the rotor 103.

During operation of the gas turbine 100, air 135 is inducted by the compressor 105 through the intake duct 104, and compressed. The compressed air which is made available at the end of the compressor 105 on the turbine side is guided to the burners 107 and mixed there with a fuel. The mixture is then combusted in the combustion chamber 110, forming the working medium 113. The working medium 113 flows from there along the hot gas passage 111 past the stator blades 130 and the rotor blades 120. On the rotor blades 120, the working medium 113 expands with impulse transmitting effect, so that the rotor blades 120 drive the rotor 103, and the latter drives the working machine which is coupled to it.

The components which are exposed to the hot working medium 113 are subjected to thermal stresses during operation of the gas turbine 100. The stator blades 130 and rotor blades 120 of the first turbine stage 112, viewed in the flow direction of the working medium 113, are thermally stressed most of all next to the heat shield blocks which line the annular combustion chamber 106.

In order to withstand the temperatures which prevail there, these are cooled by means of a cooling medium.

Also, the substrates can have a directional structure, i.e. they are single-crystal (SX-structure) or have only longitudinally oriented grains (DS-structure).

As material, iron-based, nickel-based or cobalt-based superalloys are used.

Also, the blades 120, 130 can have coatings against corrosion (MCrAlX; M is at least one element of the iron (Fe), cobalt (Co), nickel (Ni) group, X represents yttrium (Y) and/or at least one element of the rare earths), and heat by means of a thermal barrier coating. The thermal barrier coating, for example, comprises ZrO₂, Y₂O₄—ZrO₂, i.e. it is not partially or completely stabilized by yttrium oxide and/or by calcium oxide and/or by magnesium oxide.

By suitable coating methods, like, for example, electron beam physical vapor deposition (EB-PVD), stalk-shaped grains are created in the thermal barrier coating.

The stator blade 130 has a stator blade root (not shown here) which faces the inner casing 138 of the turbine 108, and a stator blade end which lies opposite the stator blade root. The stator blade end faces the rotor 103 and is fixed on a fastening ring 140 of the stator 143.

FIG. 18 shows a combustion chamber 110 of a gas turbine. The combustion chamber 110, for example, is designed as a so-called annular combustion chamber, in which a plurality of burners 102, which are arranged in the circumferential direction around the turbine shaft 103, lead into a common combustion chamber space. For this purpose, the combustion chamber 110 in its entirety is designed as an annular construction which is positioned around the turbine shaft 103.

To achieve a comparatively high efficiency, the combustion chamber 110 is designed for a comparatively high temperature of the working medium M of about 1000° C. to 1600° C. In order to enable a comparatively long period in service, even at these operating parameters which are unfavorable for the materials, the combustion chamber wall 153, on its side facing the working medium M, is provided with an inner lining which is formed from heat shield elements 155. Each heat shield element 155 is equipped on the working medium side with an especially heat resistant protective coating or is manufactured from high temperature resistant material. On account of the high temperatures inside the combustion chamber 110, moreover, a cooling system is provided for the heat shield elements 155 or for their mounting elements, as the case may be.

The heat shield elements 155 can also have holes 7, for example also with a diffuser 13 in order to cool the heat shield element 155 or to allow combustible gas to flow out.

The materials of the combustion chamber wall and their coatings can be similar to the turbine blades.

1.-44. (canceled)

45. A method for producing a hole in a coating system that has at least one metallic substrate and an outermost ceramic coating where the method includes a multiplicity of material removal steps, comprising:
removing material of the coating system in a region of a plane of the hole to be produced by at least one pulsed energy beam having a predetermined pulse length emanating from the least one energy beam emitting device wherein the at least one energy beam is moved over the surface of the component; and
removing a metallic intermediate coating or the metallic substrate of the coating system by at least one pulsed energy beam having a longer pulse duration than in previous material removal steps.

46. The method as claimed in claim 45, wherein:
longer pulse lengths are used during the first material removal steps than in one of the last material removal steps, or
shorter pulse lengths are used during the first material removal steps than in one of the last material removal steps, or
the pulse length during the progressing of the method for producing the hole is continuously altered, or
the pulse length during the progressing of the method for producing the hole is discontinuously altered, or
only two different pulse lengths are used, or
during the longer pulse durations, the at least one energy beam is not moved over the surface of the component.

47. The method as claimed in claim 45, wherein the energy beam is a laser beam.

48. The method as claimed in claim 47, wherein:
only one laser having a wavelength of 1064 nm is used, or
two or more lasers are used for producing the hole, or
two or more lasers having the same wavelength of 1064 nm or 532 nm are used to produce the hole.

49. The method as claimed in claim 47, wherein:
two or more lasers having different wavelengths of 1064 nm or 532 nm are used to produce the hole, or
the lasers are adjusted to produce like ranges of pulse lengths.
the lasers are adjusted to produce different ranges of pulse lengths.

50. The method as claimed in claim 47, wherein a plurality of lasers are:
used simultaneously, or
used consecutively with respect to time.

51. The method as claimed in claim 45, wherein:
during the first material removal steps pulse lengths which are less than or equal to 500 ns are used, or
during the first material removal steps pulse lengths which are less than or equal to 100 ns are used, and
in one of the last material removal steps pulse lengths which are greater than 100 ns are used, or
in one of the last material removal steps pulse lengths greater than 500 ns and less than 10 ms are used.

52. The method as claimed in claim 45, wherein:
during the first material removal steps pulse lengths greater than 100 ns but less than 10 ms are used, or
during the first material removal steps pulse lengths greater than 500 ns but less than 10 ms are used, and
in one of the last material removal steps pulse lengths less than or equal to 500 ns are used, or
in one of the last material removal steps pulse lengths less than or equal to 100 ns are used.

53. The method as claimed in claim 45, wherein
an outer upper region of the hole is first produced with shorter pulse lengths, and then a lower region of the hole is produced with longer pulse lengths, or
an outer edge region is first produced with shorter pulse lengths and then an inner region of the hole is produced with longer pulse lengths.

54. The method as claimed in claim 53, wherein an inner region is first produced with shorter pulse lengths, and then an outer edge region of the hole is produced with longer pulse lengths, and
the hole is produced from a surface of the component and the pulse length is varied from the outer surface to the depth of the hole.

55. The method as claimed in claim 54, wherein the longer pulse has:
a duration of 0.4 ms, and
an energy of 6 to 10 Joules, and
a power output of 10 to 50 Kilowatts.

56. The method as claimed in claim 55, wherein the shorter pulse has:
an energy between 10 to 99 millijoules, and
a power output between 1 and 9 kilowatts.

57. The method as claimed in claim 45, wherein with respect to the longer pulses, the cross sectional area of the region on the component from which material is removed corresponds to the cross sectional area of the hole to be produced.

58. The method as claimed in claim 57, wherein:
with the longer pulses, a power output of the laser of 500 Watts is used, and
with the shorter pulses, a power output of the laser of less than 300 Watts is used.

59. The method as claimed in claim 45, wherein
the coating system comprises a nickel-based, cobalt-based or iron-based superalloy substrate and a metallic coating having a composition of the MCrAlX type, where M represents at least one element of the iron, cobalt or nickel group, and also X represents yttrium and/or at least one element of the rare earths, and
wherein the component is a new or refurbished turbine blade, a heat shield element or another component part or casing part of a gas or steam turbine.

60. A device for machining a hole in a component, comprising:
a laser that produced a laser beam having a laser pulse length; and
a further laser that produces a further laser beam having a further laser pulse length that is different than the laser pulse length wherein at least one laser beam is movable in one plane during the machining of the component with shorter laser pulse lengths.

61. The device as claimed in claim 60, wherein the device has at least one mirror which is used in order to direct the laser beam onto the component which is to be machined.

62. The device as claimed in claim 61, wherein the device has two lasers and two mirrors which can direct the laser beams simultaneously or consecutively onto the component.

63. The device as claimed in claim 62, wherein the device has a lens which directs the laser beam of the laser onto the component.

64. The device as claimed in claim 63, wherein the device has at least two lenses which can simultaneously direct the laser beam and the further laser beam onto different regions of the component.
